(19) United States
(12) Patent Application Publication
(10) Pub. No.: US 2025/0125107 A1
(43) Pub. Date: Apr. 17, 2025

(54) Regulating Switch and Electric Appliance

(71) Applicant: Shenzhen Unitweld Welding and Motor Co., Ltd, Shenzhen (CN)

(72) Inventor: GuoHua Zheng, Shenzhen (CN)

(21) Appl. No.: 19/002,620

(22) Filed: Dec. 26, 2024

(51) Int. Cl. H01H 19/02; H01H 19/08; H01H 19/14

(52) U.S. Cl. CPC H01H 19/025; H01H 19/08; H01H 19/14

(57) ABSTRACT

A regulating switch and electric appliance includes a rotary encoder, a regulating rotary knob and a display assembly. The rotary encoder further includes a hollow rotary encoder holder and a rotary assembly arranged on the outer periphery of the rotary encoder holder. The rotary assembly rotates relative to the rotary encoder holder. The display assembly is connected to the rotary encoder holder. The regulating rotary knob is connected to the rotary assembly, and a window for observing the display assembly is arranged on the regulating rotary knob. The electric appliance includes the said regulating switch. The regulating switch integrates display and regulating functions, which effectively saves space inside the electric appliance and reduces energy waste. Users can conveniently and quickly regulate the function of the electric appliance through only one regulating switch, thereby effectively improving the user experience.

### TECHNICAL FIELD

The present invention belongs to the technical field of equipment regulating devices, and particularly relates to a regulating switch and electric appliance.

### TECHNICAL BACKGROUND

There are several main defects in the existing electric appliance regulating panel:

(1) Components such as voltage display, current display and function indicator lights are usually designed to be arranged in a single row, resulting in the layout of the regulating panel not being compact enough and occupying a large area, which is not suitable for use in environments with limited space;

(2) Multiple components arranged separately often require more energy to maintain operation, resulting in high energy consumption, which is not conducive to energy conservation, emission reduction and sustainable development;

(3) The setting of multiple function selection buttons may increase the complexity of users' operations. Especially when parameters need to be adjusted quickly, users may need to spend more time to identify and operate the correct buttons, so the user experience needs to be improved.

### INVENTION CONTENT

In order to overcome the defects of the existing technology, the present invention provides a regulating switch and electric appliance, wherein the electric appliance comprises the regulating switch. The regulating switch integrating display and regulating functions, which can effectively save space inside the electric appliance and reduce energy waste. Users only need to use a regulating switch to conveniently and quickly regulate the function, effectively improving the user experience.

The technical scheme adopted by the present invention for solving the technical problems is as follows:

A regulating switch comprises a rotary encoder, a regulating rotary knob and a display assembly, wherein the rotary encoder comprises a hollow rotary encoder holder and a rotary assembly arranged on the outer periphery of the rotary encoder holder. The rotary assembly can rotate relative to the rotary encoder holder. The display assembly is connected to the rotary encoder holder. The regulating rotary knob is connected to the rotary assembly. And a window for observing the display assembly is arranged on the regulating rotary knob.

Preferably, the regulating rotary knob is of cylindrical structure with openings at two ends. A protruding fixture block and a first inverted button are arranged on the inner wall of the regulating rotary knob. A first slot and a second slot are arranged on the outer periphery of the rotary assembly. The first slot extends downward from the top side of the rotary assembly, and the second slot extends downward from the middle part of the rotary assembly.

Preferably, the display assembly comprises a display stand and a display screen arranged on the display stand. The display stand comprises a supporting part and a connect part. One side of the supporting part is connected to the display screen, the other side of the supporting part is connected to the connect part. A second inverted button is arranged on the outer periphery of the connect portion. A third slot is arranged on the inner wall of the rotary encoder holder, and a protruding blocking lump is arranged in the third slot.

Preferably, at least one gap extending axially along the connect part is provided on one end of the connect part away from the supporting part.

Preferably, the outer edge of the supporting part is provided with a plurality of evenly distributed limit slots, and the outer edge of the display screen is provided with a plurality of evenly distributed limit blocks extending toward the supporting part.

Preferably, a glass is arranged on one end of the regulating rotary knob.

Preferably, the inner wall of the regulating rotary knob is provided with a first annular step, and the first annular step is used to support the supporting part in the display stand and the display screen arranged on the supporting part.

Preferably, a second annular step is arranged inside the regulating rotary knob, the second annular step is arranged at intervals with the first annular step. The regulating switch also comprises a glass, the glass is fixedly connected to the surface of the second annular step.

Preferably, the interval between the second annular step and the first annular step is greater than a sum thicknesses of the supporting part and the display screen.

The present invention also provides an electric appliance, comprising the regulating switch as described above.

The beneficial effects of the present invention:

The present invention provides a regulating switch and electric appliance. The electric appliance comprises the regulating switch. The regulating switch integrates display and regulating functions, which can effectively save space inside the electric appliance and reduce energy waste. And the overall structure of the regulating switch is simple, which can be conveniently installed on the electric appliance for use, and is suitable for various electric appliances and machines with functional regulating and display needs. Users only need to use a regulating switch to conveniently and quickly regulate the function, which effectively improves the user experience.

### DESCRIPTION OF FIGURES

FIG. 1 is a schematic diagram of a regulating switch of the present invention;

FIG. 2 is an exploded view of the regulating switch of the present invention;

FIG. 3 is a schematic diagram of the rotary encoder of the present invention;

FIG. 4 is a schematic diagram of the regulating rotary knob in the present invention;

FIG. 5 is an exploded view of the display assembly in the present invention;

### DESCRIPTION OF MARKS IN FIGURES

1-rotary encoder; 10-rotary encoder holder; 101-third slot; 102-blocking lump; 11-rotary assembly; 111-first slot; 112-second slot; 2-regulating rotary knob; 20-window, 21-glass; 22-fixture block; 23-first inverted button; 24-first annular step; 25-second annular step; 3-display assembly; 30-display stand; 301-supporting part; 3011-limit slot; 302-connect part; 3021-second inverted button; 3022-gap; 31-display screen; 311-limit block

### DETAILED DESCRIPTION OF THE EMBODIMENTS

Below is a further detailed description of the present invention based on the figures.

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

The present invention provides a regulating switch and electric appliance. The regulating switch integrates display and adjustment functions, which can effectively save space inside the electric appliance and reduce energy waste. And the overall structure of the regulating switch is simple, which can be conveniently installed on the electric appliance for use, and is suitable for various electric appliances and machines with functional regulating and display needs.

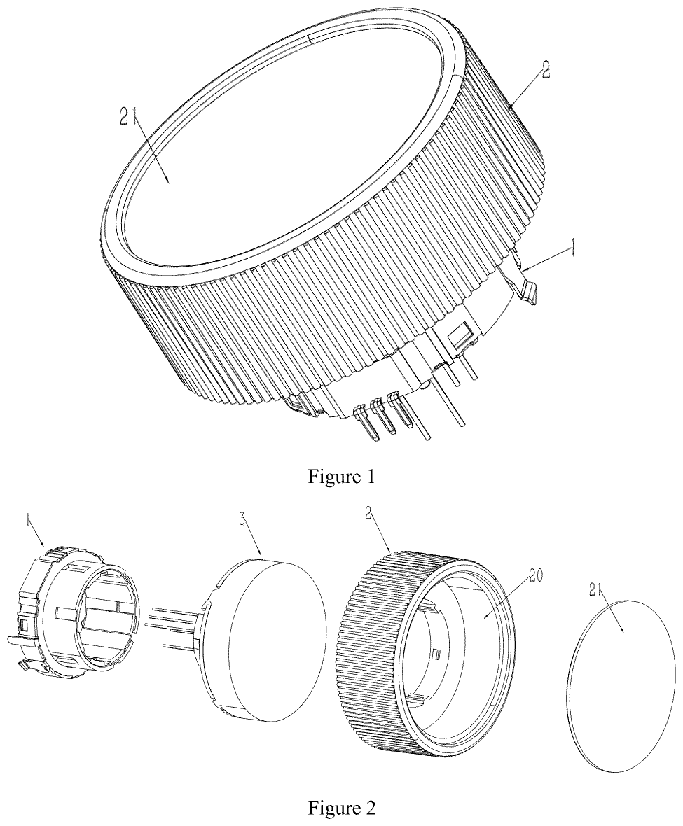

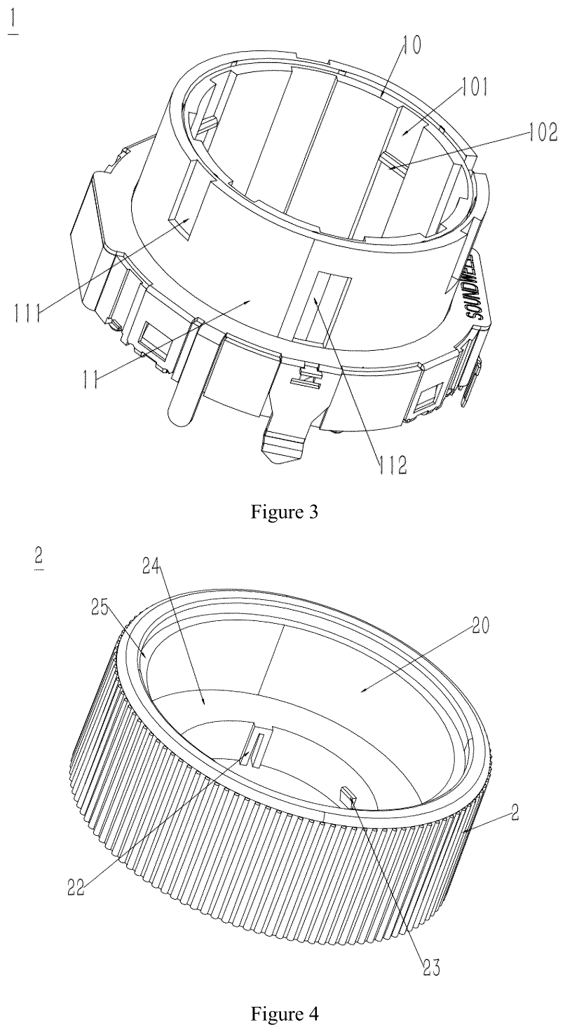

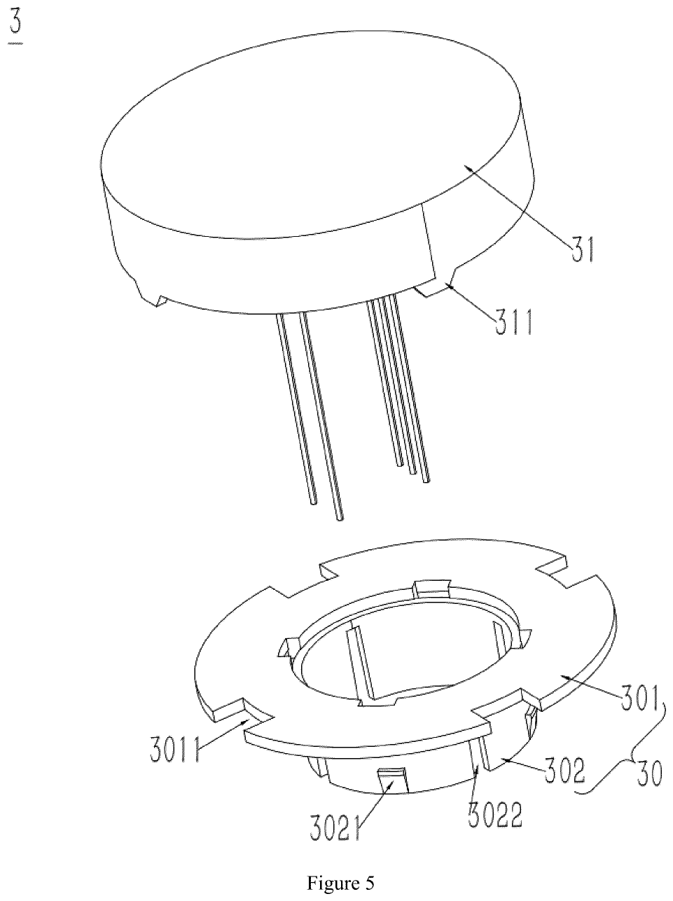

Referring to FIGS. 1 to 5, the embodiment provides a regulating switch, comprising a rotary encoder 1, a regulating rotary knob 2 and a display assembly 3. The rotary encoder 1 comprises a hollow rotary encoder holder 10 and a rotary assembly 11 arranged on the outer periphery of the rotary encoder holder 10. The rotary assembly 11 can rotate relative to the rotary encoder holder 10. The display assembly 3 is connected to the rotary encoder holder 10. The regulating rotary knob 2 is connected to the rotary assembly 11. The regulating rotary knob 2 is provided with a window 20 for observing the display assembly 3.

It should be noted that the rotary encoder 1 is an analog encoder. As a sensor element, when the rotary assembly 11 in the rotary encoder 1 rotates, the rotary encoder 1 can convert the rotating physical signal into an electrical signal, and convert the continuous physical signal into a change in voltage or current. It can be applied to some application sites that require voltage regulation or current regulation.

Understandably, the regulating switch provided in this embodiment can be applied to various mechanical equipment and products with regulating and display functions. Correspondingly, a control circuit board needs to be arranged inside the product, and the rotary encoder 1 and the display assembly 3 in the regulating switch need to be electrically connected to the control circuit board to realize the corresponding functions. The hollow rotary encoder holder 10 allows the cable connecting the display assembly 3 and the control circuit board to pass through, so that the cable will not interfere with the normal operation of the rotary assembly 11 and the regulating rotary knob 2 in the rotary encoder 1; at the same time, the cable is protected inside the rotary encoder holder 10, reducing the possibility of accidental touching or damaging, and the risk of safety accidents caused by cable problems.

It should be noted that those skilled in the art should be aware of the connection circuit and control principle of the control circuit board, the encoder and the display screen 31, and no further elaboration is given here.

The steps for assembling and using the regulating switch of this embodiment are as follows:

First, the rotary assembly 11 in the rotary encoder 1 is sleeved on the outside of the rotary encoder holder 10, the regulating rotary knob 2 is connected to the outer periphery of the rotary assembly 11, and the display assembly 3 is assembled into the hollow rotary encoder holder 10 along the window 20 set on the regulating rotary knob 2, and connected with the rotary encoder holder 10. Users rotates the regulating rotary knob 2 to drive the rotary assembly 11 in the rotary encoder 1 to rotate, output the regulating signal to the control circuit board. And the control circuit board performs the corresponding regulating function, while the rotary encoder holder 10 and the display assembly 3 remain stationary; at the same time, the control circuit board processes the regulating signal, and then uploads the regulating information to the display assembly 3 to display various regulating effects. Users can observe the information displayed on the display assembly 3 through the window 20 on the regulating rotary knob 2 to determine whether the regulating is in place.

In addition, a button can be set on the control circuit board. Users can trigger the button on the control circuit board by pressing the regulating switch to select a function. After selecting the function to be regulated, users can rotate the regulating switch to regulate it. By integrating the function selection part on the control circuit board and triggering it through the regulating switch, there is no need to set other selection buttons on the surface of the electric appliance, which can optimize the space inside the electric appliance.

Preferably, the regulating rotary knob 2 is of a cylindrical structure with openings on two ends, and the opening at one end of the regulating rotary knob 2 away from the rotary encoder 1 serves as a window 20, which facilitates users to observe the display screen 31. The inner wall of the regulating rotary knob 2 is provided with a protruding fixture block 22 and a first inverted button 23, and the outer periphery of the rotary assembly 11 is provided with a first slot 111 and a second slot 112. The first slot 111 extends downward from the top side of the rotary assembly 11, the second slot 112 extends downward from the middle part of the rotary assembly 11, and the first slot 111 and the second slot 112 are staggeredly distributed on the outer periphery of the rotary assembly 11.

Preferably, a plurality of first slots 111 and second slots 112 are arranged and evenly distributed on the outer wall of the rotary encoder holder 10, and a plurality of first inverted buttons 23 and fixture blocks 22 are arranged and evenly distributed on the inner wall of the regulating rotary knob 2. When connecting the regulating rotary knob 2 and the rotary encoder holder 10, there is no need to consider the installation direction, only need to align any fixture block 22 with the first slot 111. And after the first inverted button 23 and the second slot 112 are aligned, press the regulating rotary knob 2 in the direction of the encoder, and engage the first inverted button 23 in the second slot 112, so as to connect the regulating rotary knob 2 and the rotary encoder holder 10.

Preferably, the display assembly comprises a display stand 30 and a display screen 31 arranged on the display stand 30. The display stand 30 comprises a supporting part 301 and a connect part 302. One side of the supporting part 301 is connected to the display screen 31, the other side of the supporting part 301 is connected to the connect part 302. A second inverted button 3021 is arranged on the outer periphery of the connect part 302, a third slot 101 is arranged on the inner wall of the rotary encoder holder 10, and a protruding blocking lump 102 is arranged in the third slot 101.

Among them, the third slot 101 extends axially along the rotary encoder holder 10, the blocking lump 102 is located in the middle of the third slot 101. The second inverted button 3021 is provided with a guidance bevel. As long as the third slot 101 and the second inverted button 3021 are aligned and pressed so that the second inverted button 3021 and the blocking lump 102 form a snap-fit relationship, the blocking lump 102 can limit the second inverted button 3021 and prevent the second inverted button 3021 from detaching from the third slot 101, thereby ensuring a firm connection between the connect part 302 and the rotary encoder holder 10.

Preferably, a plurality of third slots 101 are arranged and evenly distributed on the inner wall of the rotary encoder holder 10, and a plurality of second inverted buttons 3021 are arranged and also evenly distributed on the outer periphery of the connect part 302. When connecting the display stand 30 and the rotary encoder holder 10, there is no need to consider the installation direction, only need to align and press any third slot 101 with the second inverted button 3021, to connect the rotary encoder holder 10 and the connect part 302, and the display stand 30 is fixedly connected to the rotary encoder holder 10.

Further, at least one gap 3022 extending axially along the connect part 302 is arranged on one end of the connect part 302 away from the supporting part 301.

In this embodiment, four gaps 3022 are evenly arranged on the connect part 302, and the entire connect part 302 stand is made of a material with certain elastic properties. In this embodiment, the display stand 30 is made of a plastic material. In another embodiment, other polymer-supported materials or flexible silicone materials can be selected. It is understandable that in the process of inserting the connect part 302 into the interior of the rotary encoder holder 10, the gaps 3022 of the connect part 302 can be compressed, so that the contour of the outer periphery of the connect part 302 becomes smaller, which can facilitate users to easily assemble the connect part 302 into the interior of the rotary encoder holder 10. And after being assembled in place, the connect part 302 can use its own elasticity to restore to the initial state.

Preferably, the outer edge of the supporting part 301 is provided with a plurality of evenly distributed limit slots 3011, and the outer edge of the display screen 31 is provided with a plurality of evenly distributed limit blocks 311 extending toward the supporting part 301, and the limit blocks 311 are matched with the limit slots 3011. When connecting the display screen 31 to the supporting part 301, there is no need to consider the installation direction, only need to align the limit blocks 311 with the limit slots 3011 for connection.

Further, a first annular step 24 is arranged on the inner wall of the regulating rotary knob 2, and the first annular step 24 is used to support the supporting part 301 in the display stand 30 and the display screen 31 arranged on the supporting part 301.

Understandably, since the display stand 30 is fixedly connected to the rotary encoder holder 10, when the regulating rotary knob 2 and the rotary assembly 11 in the encoder rotate, the display stand 30 and the display screen 31 will remain stationary. In addition, the display stand 30 is located between the display screen 31 and the first annular step 24, which can further isolate the display screen 31 and the regulating rotary knob 2 to prevent the regulating rotary knob 2 from interfering with the display screen 31.

Further, a glass 21 is arranged at the window 20 of the regulating rotary knob 2. Specifically, a second annular step 25 is arranged on the inner wall of the regulating rotary knob 2 close to the window 20, the second annular step 25 is arranged at intervals with the first annular step 24, and the glass 21 is fixedly connected to the surface of the second annular step 25.

It should be particularly noted that the interval between the second annular step 25 and the first annular step 24 is greater than the thickness of the supporting part 301 and the display screen 31. That is to say, when the regulating rotary knob 2 and the display assembly 3 are both connected to the rotary encoder holder 10, the second annular step 25 is located above the display screen 31 and has a certain distance from the display screen 31, ensuring that when the regulating rotary knob 2 drives the glass 21 to rotate, the glass 21 will not interfere with the display screen 31.

The glass 21 is made of a light-transmitting material and has a perspective effect, which makes it convenient for users to observe the information on the display screen 31 through the glass 21. It can also protect the display screen 31 and prevent accidental impact or scratches from damaging the display, so as not to affect the display effect of the display screen 31. In addition, the glass 21 and the regulating rotary knob 2 wrap the remaining components of the regulating switch, which can play a dust-proof effect, prevent dust from entering the interior of the regulating switch, reduce the failure rate of the internal components of the regulating switch caused by dust, and improve the reliability of the regulating switch.

In addition, this embodiment also provides an electric appliance using the regulating switch described above. Based on the above description, it can be seen that the regulating switch in this embodiment integrates the functions of display and regulating, which can effectively save space inside the electric appliance and reduce energy waste. The overall structure of the regulating switch is simple and can be easily installed on the product for use. It is suitable for various electric appliances and machines with functional regulating and display needs.

Understandably, under the guidance of the above embodiments, those skilled in the filed can combine various implementation methods in the above embodiments to obtain technical solutions of multiple implementation methods.

The above description is only a preferred embodiment of the present application and is not to limit the present application. Any modifications, equivalent substitutions and improvements made within the spirit and principles of the present application should be included in the protection scope of the present application.

1. A regulating switch, comprises a rotary encoder, a regulating rotary knob and a display assembly, wherein the rotary encoder further comprises a hollow rotary encoder holder and a rotary assembly arranged on the outer periphery of the rotary encoder holder; the rotary assembly can rotate relative to the rotary encoder holder; the display assembly is connected to the rotary encoder holder; the regulating rotary knob is connected to the rotary assembly, and a window for observing the display assembly is arranged on the regulating rotary knob.

2. The regulating switch according to claim 1, wherein the regulating rotary knob is of a cylindrical structure with openings at two ends; an inner wall of the regulating rotary knob is provided with a protruding fixture block and a first inverted button; an outer periphery of the rotary assembly is provided with a first slot and a second slot; the first slot extends downward from a top side of the rotary assembly, and the second slot extends downward from a middle part of the rotary assembly.

3. The regulating switch according to claim 1, wherein the display assembly comprises a display stand and a display screen arranged on the display stand; the display stand further comprises a supporting part and a connect part; one side of the supporting part is connected to the display screen, and other side of the supporting part is connected to the connect part; a second inverted button is arranged on an outer periphery of the connect part; a third slot is arranged on inner wall of the rotary encoder holder; and a protruding blocking lump is arranged in the third slot.

4. The regulating switch according to claim 3, wherein at least one gap extending axially along the connect part is arranged at one end of the connect part away from the supporting part.

5. The regulating switch according to claim 3, wherein a plurality of evenly distributed limit slots are arranged on outer edge of the supporting part, and a plurality of evenly distributed limit blocks are arranged on outer edge of the display screen and extend toward the direction of the supporting part.

6. The regulating switch according to claim 1, wherein the window is provided with a glass.

7. The regulating switch according to claim 6, wherein a first annular step is arranged on the inner wall of the regulating rotary knob, and the first annular step is used to support the supporting part in the display stand and the display screen.

8. The regulating switch according to claim 7, wherein a second annular step is arranged inside the regulating rotary knob, the second annular step is arranged at intervals with the first annular step, and the glass is fixedly connected to the surface of the second annular step.

9. The regulating switch according to claim 8, wherein the interval between the second annular step and the first annular step is greater than a sum thicknesses of the supporting part and the display screen.

10. An electric appliance, comprises the regulating switch according to claim 1.

11. An electric appliance, comprises the regulating switch according to claim 2.

12. An electric appliance, comprises the regulating switch according to claim 3.

13. An electric appliance, comprises the regulating switch according to claim 4.

14. An electric appliance, comprises the regulating switch according to claim 5.

15. An electric appliance, comprises the regulating switch according to claim 6.

16. An electric appliance, comprises the regulating switch according to claim 7.

17. An electric appliance, comprises the regulating switch according to claim 8.

18. An electric appliance, comprises the regulating switch according to claim 9.
